(19) United States
(12) Patent Application Publication
(10) Pub. No.: US 2022/0219485 A1
(43) Pub. Date: Jul. 14, 2022

(54) METHOD FOR PRODUCING A DECORATIVE PANEL

(71) Applicant: SCHOTT VTF, Troisfontaines (FR)

(72) Inventor: Benoît KOLHEB, Reding (FR)

(73) Assignee: SCHOTT VTF, Troisfontaines (FR)

(21) Appl. No.: 17/612,825

(22) PCT Filed: Jun. 2, 2020
(86) PCT No.: PCT/EP2020/065143

§ 371 Date: Nov. 19, 2021

(30) Foreign Application Priority Data
Jun. 6, 2019 (FR) FR1906028

(51) Int. Cl. B44C 1/17; B44C 5/04; B44C 1/14; B23K 26/322; C03C 17/36; C03C 17/40

(52) U.S. Cl. CPC B44C 1/1704; B44C 5/0407; B44C 5/0415; B44C 1/14; B23K 2103/54; C03C 17/3684; C03C 17/40; C03C 2217/72; C03C 2218/17; B23K 26/322

(57) ABSTRACT

A method for producing a decorative panel, appearing and/or feeling like a machined metal, including taking a glass substrate, including at least one first surface; and one or more solid metal films, made of one or more metal(s) or metal alloy(s); generating a pulsed LASER beam; directing a metal deposition on at least the first surface, disposing the one or more metal film(s) facing the at least first surface, between the substrate and the LASER source, and applying the LASER beam on the one or more metal film(s) transferring the one or more metal(s) or metal alloy(s) onto the at least first surface, forming a coating including a metal layer covering all or part of the at least first surface, the metal layer including a top surface; and surfacing the metal coating top surface to alter the surface condition giving it the appearance and/or feel of a machined metal.

### OBJECT OF THE INVENTION

The present invention relates to a method for producing a decorative panel, in particular a cover panel, of an electrical home appliance, a heating device, a room in a housing unit, or for furniture, the panel comprising a substrate made of glass which is metallised. The invention also relates to such a panel.

### STATE OF THE ART

Metal panels are used in many technical fields, as so-called “decorative” panels, as constituent elements for a siding or partition, or a wall, or as wall covering. However, such panels that are referred to as “conventional”, are difficult to handle and manipulate, and are expensive to manufacture, because they are solid panels, made from a block of metal, therefore requiring a large amount of metal, which consequently significantly reduces use thereof.

In order to replicate the aesthetics of metal panels, a more economical solution has been proposed which consists in covering a substrate made of glass with a coating that has the appearance of a metal.

Such panels are generally obtained by covering the surface of the glass with a base coating of primer, followed by projecting a layer of metal particles, over which a topcoat layer of a clear colourless varnish is applied. However, the disadvantage with such panels is that their aesthetic appearance leaves much to be desired, in that the metal particles are distinctly visible through the topcoat varnish layer.

In the particular field of electrical home appliances, metal decorative panels, which were often used in order to cover or clad appliances, are also replaced with glass panels, which offer the advantage of being lighter, less expensive, and being able to bear a wide variety of decorative patterns, inscriptions, signs, logos or images. They generally comprise of a substrate made of glass, covered with one or more coloured enamels, or paints, that replicate the visual appearance of a metal. Usually, such enameled panels are obtained by the use of masks or stencils, based on a succession of screen printing operations, or by digital printing.

Despite such enameled decorative panels exhibiting an improved final aesthetic appearance, given that they are enameled panels, they consequently have neither the real visual appearance, nor indeed the real feel, of a machined metal.

Moreover, still with regard to the particular field of electrical home appliances, the patent document EP2573204 describes a production method for obtaining a hot plate, comprising a substrate, covered with a metal layer that is vacuum deposited in the vapour phase, the substrate and the metal layer thereafter being subjected to a heat treatment process. By means of laser ablation the metal layer is then removed from the substrate in certain places in order to electrically isolate certain regions of the metal layer, and to identify the functional zones therein. The metal layer is then covered with a protective dielectric layer.

In addition to the fact that such a panel is a functional panel, it has neither the aesthetic aspects, in particular surface irregularities, nor the feel, of conventional metal decorative panels that have been machined, which exhibit an irregular appearance, because the more or less coarse grained brushes, used to structure the metal by friction, wear out and never brush the metal in the same place and in the same manner. The brushing of the metal is irregular and uneven. It is not possible to obtain such a result with laser ablation, because the laser beam works by reproduction of patterns, which in the end creates a regularity in the appearance.

In the electronics field, a technological field that is far removed from the invention, the deposition of a thin layer of metal, of a uniform and regular thickness, is generally carried out by vacuum evaporation techniques which are not easy because they require a high vacuum, precise control of the atmosphere in which the deposition process takes place, and need imposing and expensive equipment.

Moreover, still in the context of the electronics field, a technique has been proposed that consists in the metalising of a substrate made of silicon or glass by the use of a LASER, either according to an indirect method or according to a direct method.

The indirect method consists in irradiating, by means of a LASER, a metal material disposed under a transparent substrate to be covered that is facing the material, with the LASER beam passing through the substrate in order to vapourise the material and transfer it on to the substrate, as has been described for example in the document WO2010104651.

The direct method consists in disposing the material to be transferred over the substrate, between the substrate and the LASER beam, with the latter happening to strike the material, on the surface opposite the surface facing the substrate, so as to project it onto the substrate, with the material being in direct contact with the substrate, as described in the document EP2064748, or being disposed at a distance from the substrate, as described in the document WO2015189432.

The indirect transfer method, and especially the direct transfer method, present the disadvantage of producing a metal layer which exhibits irregularities in thickness; indeed, if the laser beam is operated discontinuously, the deposition is effected in the form of spots, or else in the form of lines if the laser beam is operated continuously, respectively with a diameter or a width, corresponding to the size of the laser beam. This generates pixelation effects, with a portion of the substrate between two deposition spots or two deposition lines, not being covered with metal; or indeed a roughness, due to excess material if the laser effects deposits in passes that overlap. By virtue of these irregularities in deposition, the metal layer does not have the visual appearance and/or the feel of a plate made of metal, in particular a machined metal.

### AIMS OF THE INVENTION

The present invention seeks to provide a metallised panel, and such a metallised decorative panel, which do not present the drawbacks of the state of the art.

The present invention seeks to provide an alternative to the existing solutions in the state of the art.

The present invention seeks to provide a production method that makes it possible to obtain a decorative panel made of glass, that has an enhanced visual appearance and/or improved feel which is close to the visual appearance and/or the feel of a machined metal.

The present invention also seeks to provide a method for producing a decorative panel, that is fast, and easy to implement.

### SUMMARY OF THE INVENTION

The present invention relates to a method for producing a panel according to the invention, comprising the steps of taking a substrate made of glass, comprising at least one first surface, preferably also a second surface, opposite the said first surface, and optionally also at least one first edge, preferably a plurality of edges; taking one or more solid metal films, made of one or more metal(s) or metal alloy(s); taking a LASER source capable of generating a pulsed LASER beam; effecting a direct metal deposition on at least the first surface, by disposing the one or more metal film(s) facing, at a distance from or in contact with, the at least first surface, between the glass substrate and the LASER source, and by applying the LASER beam on the one or more metal film(s) in order to transfer the one or more metal(s) or metal alloy(s) directly onto the at least first surface, according to a given predetermined pattern, in order to form a coating comprising a metal layer covering all or part of the at least first surface, the metal layer comprising a top surface; and surfacing the top surface in order to alter the surface condition thereof, so as to give it the visual appearance and/or the feel of a metal that has been machined.

According to preferred embodiments of the invention, the method according to the invention comprises at least one, or any suitable combination, of the following characteristic features:
the surfacing step comprises a step of polishing, brushing, embossing, goffering, or a combination thereof;
the step of depositing of the one or more metal(s) or metal alloy(s) of the one or more metal film(s), directly on the at least first surface of the substrate made of glass, is repeated several times, in order to apply, on the at least first surface, a multitude of layers made up of one particular metal or metal alloy, or different metals or different metal alloys, it being possible for the layers to be superimposed, overlapping, or adjacent, and to include patterns that may possibly be identical or different between the layers;
the step of depositing of the one or more metal(s) or metal alloy(s) of the one or more metal film(s) is repeated in order to form a metal layer covering all or part of the second surface and/or of multiple edges of the substrate made of glass;
the one or more metal film(s) are deposited on a surface of a transfer substrate, that is transparent to the LASER beam, the surface of the transfer substrate being disposed to be facing the at least first surface and/or the at least first edge of the substrate to be covered;
the method further comprises a preliminary step of covering all or part of the substrate made of glass with one or more enamel(s);
the method further comprises a pretreatment step, carried out before the step of transferring the one or more metal(s) or metal alloy(s), and consisting in: removing the surface contaminants present on at least the first and/or the second surface and/or on the one or more edge(s) of the substrate made of glass; or the surface structuring, to be at least two dimensional, preferably three dimensional, of the one or more surface(s) and/or of the one or more edge(s) of the substrate made of glass;
the decorative panel is a cover panel, for covering an electrical home appliance, a heating device, a room in a housing unit, or for decorating furniture.

The present invention also relates to a decorative panel obtained by the method according to the invention.

The decorative panel comprises of a substrate made of glass comprising at least one first surface, preferably also a second surface, opposite the first surface, and optionally also at least one first edge, preferably a plurality of edges; the one or two surface(s) and/or one or more edge(s) being covered, totally or partially, with a coating that is composed of at least one metal layer, comprising of one or more metal(s) or metal alloy(s), deposited by direct transfer making use of a LASER beam, and forming one or more decorative pattern(s); the metal layer having a top surface, which has been surfaced in order to obtain the visual appearance and/or the feel of a metal that has been machined.

According to preferred embodiments of the invention, the decorative panel according to the invention comprises at least one, or any suitable combination, of the following characteristic features:
the visual appearance and/or feel of a machined metal is selected from among the visual appearance and/or feel of a polished metal, brushed metal, goffered metal, or embossed metal, or a combination thereof;
the metal layer comprises of a multitude of layers of one particular metal or metal alloy, or of different metals and/or different metal alloys, the thin layers being superimposed, adjacent or overlapping relative to each other;
the top surface of the metal layer, is covered with a protective varnish coating which does not alter the visual appearance and/or the feel of the said top surface.

The present invention also relates to the use of the decorative panel according to the invention for decorating an electrical home appliance, for decorating a room in a housing unit, or for decorating furniture.

### BRIEF DESCRIPTION OF THE FIGURES

FIG. 1 is a schematic representation of a side view of a panel according to the invention.

FIG. 2 is a schematic representation of a first embodiment of the method according to the invention.

FIG. 3 is a schematic representation of a second embodiment of the method according to the invention.

### DETAILED DESCRIPTION OF THE INVENTION

In the remainder of the description and the claims, the term “length” is used to describe the greatest of the measurements of one side of any geometric shape, for example the major radius of an ellipsoid or an ellipse, the base or height of a triangle, the length of a trapezoid or a rectangle. The term “width” is used to describe the smallest of the measurements, for example the minor radius of an ellipsoid or an ellipse, the base or height of a triangle, the width of a trapezoid or a rectangle; and the terms “length” and “width” may be used interchangeably, for example to denote the measurement of the radius of a disc, the side of a square.

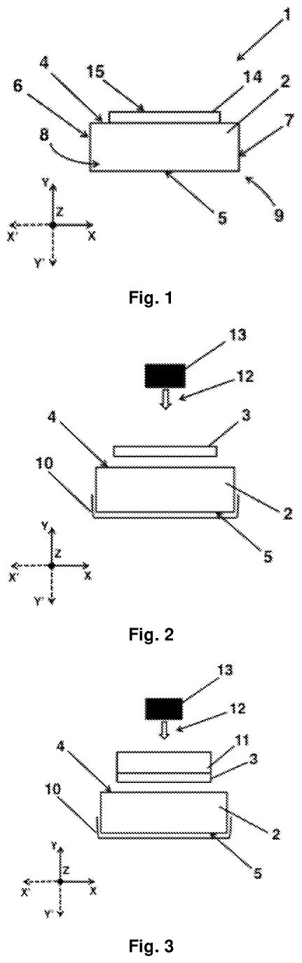

The terms “top”, “bottom”, “upper”, “lower”, “front”, “rear”, “vertical”, or “horizontal” refer to the horizontal position of the panel according to the invention, and the elements implemented according to the method of the invention, as represented in FIGS. 1 to 3.

The method of the invention operationally implements a step of metalising a substrate 2 made of glass, a step of transferring one or more metal(s) or metal alloy(s), which is referred to as “direct” (FIGS. 2 and 3), for a deposition, over the entirety of one or more surface(s) of the substrate 2, or a structured deposition of metal, that is to say over a part of the one or more surface(s) of the substrate 2, preferably based on a decorative pattern which may possibly be or include inscriptions, signs, geometric shapes/forms, logos, and images.

The method according to the invention comprises the steps of taking, or producing, a substrate 2 made of glass, optionally covered partially or completely, with one or more layer(s) of one or more enamel(s); and taking, or producing one or more metal film(s) 3, or metal sheet(s), in the solid state.

The substrate 2 is substantially rigid and inflexible. It exhibits a mechanical resistance, to bending and/or torsional stresses, that is sufficient to keep it from deforming under the action of a bending and/or torsional force. It is also at least thermally inert, advantageously also physically and chemically inert to the material(s) with which it is covered or in contact.

The substrate 2 is preferably transparent, or indeed partially transparent, optically in the visible range, in the thickness and/or width and/or length thereof. It can be sandblasted and/or screen printed and/or coloured over all or part of these surfaces or these edges.

In one preferred embodiment of the invention, the substrate 2 is a soda-lime glass that is transparent or dyed (self-colour), optionally having various layers, such as anti-bacterial, anti-reflective, for example of the type known under the brand name Matelux®, chrome-plated, with low-emissivity, for example of the type known under the trade name Planibel Clear or Planibel low-E IsoComfort, marketed by the company AGC; or a borosilicate, for example known under the brand name Borofloat® 33. Preferably, the glass has a high SiO₂ content, a content level advantageously between 69% and 81% by weight, and with a light transmission rating that can range up to 90%. The glass optionally may have previously undergone a heat treatment of such type as hardening, annealing, tempering, or bending.

The substrate 2 has a shape and form, a thickness and dimensions that are adequate and appropriate, or compatible, with the end use of the panel 1, or of the elements that include such a panel 1.

The substrate 2 is substantially planar. It is preferably a flat glass. It comprises at least one first surface 4, that is continuous and substantially planar, preferably a second surface 5, that is continuous and substantially planar, opposite the said first surface 4 (FIGS. 1 to 3).

Preferably, the substrate 2 has a transverse cross section, therefore in the plane formed by the surface 4 or the surface 5, in the plane X-Z, having a form that is circular, elliptical, polygonal, trapezoidal or indeed a quadrilateral, advantageously a diamond-shaped, square or rectangular cross section. Preferably, the substrate 2 has a longitudinal cross section, therefore in the plane X-Y, and/or a transverse cross section, therefore in the plane Y-Z, which are perpendicular to the plane formed by the surface 4 or the surface 5, having a form that is circular, elliptical or polygonal, trapezoidal or indeed a quadrilateral, advantageously a square or rectangular cross section, of a trapezoid or a right-angled trapezoid.

The substrate 2 comprises at least one first lateral edge 6, and in the embodiments in which it has a transverse and/or parallelepiped longitudinal cross section, for example square(s) or rectangular(s), it comprises a second lateral edge 7, opposite the first lateral edge 6, a leading-front edge 8 and trailing-rear edge 9, opposite the leading-front edge 8.

Preferably, the first lateral edge 6 and/or the second lateral edge 7, the leading-front edge 8 and/or the trailing-rear edge 9 is/are chamfered.

In particular embodiments of the invention, all or part of the surfaces 4, 5 and/or the edges 6, 7, 8, 9 may be covered with one or more layer(s) of one or more enamel(s), a deposition being effected prior to, or after, the direct deposition of the metal layer 14, the one or more enamel(s) being disposed in superimposed or adjacent manner relative to one another. In these embodiments of the invention, the coating covering the substrate 2 is then constituted of the metal layer 14 and of the one or more layer(s) of enamel(s).

Preferably, the substrate 2 is deposited on a substrate holder 10 on which it is fixed during the metallisation process (FIGS. 2 and 3). However, the substrate holder 10 may be movable in rotational motion, for example along the axis Y-Y′, and/or in translational motion, along the axis Y-Y′ and/or the axis X-X′. For these purposes, the substrate holder 10 may be coupled to a multi-axis motion control mechanism for moving and positioning the substrate holder 10 in different orientations and at different angles. Once its position and its orientation have been determined, the substrate holder 10 may be fixed, or mobile, during the process of metallisation of the substrate 2.

The one or more metal film(s) 3 are preferably single-layer films and are made of a single metal or a single alloy of metals. However, it is also possible to provide for the use of one or more multilayer films 3 comprising of multiple layers of the same metal or metal alloy or of different layers of different metals or metal alloys.

Preferably, the metal is selected from among aluminum, copper, iron, stainless steel, magnesium, silver, chromium, titanium, zinc, tin and alloys thereof.

The one or more metal film(s) 3 have a thickness of between 10 and 300 μm.

Preferably, the one or more metal film(s) 3 may be present in the form of one or more continuous strips in order to constitute a continuous source of metal to be transferred.

Preferably, the one or more metal film(s) 3 may be deposited, by any suitable means on a transfer substrate 11, for example a substrate made of glass that is transparent to the beam 12 of a LASER 13, and cover at least one of these surfaces, the surface intended to be facing the surface 4, 5 or the edge 6, 7, 8 or 9 of the substrate 2, to be covered (FIG. 3).

Preferably, the transfer substrate 11 is movable in rotational motion, for example along the axis Y-Y′, and/or in translational motion, along the axis Y-Y′ and/or the axis X-X′. For these purposes, the transfer substrate 11 may be coupled to a multi-axis motion control mechanism for moving and positioning the transfer substrate 11 in different orientations and at different angles. Once its position and its orientation have been determined, the transfer substrate 11 may be fixed, or mobile, during the process of metallisation.

Preferably, the method according to the invention comprises a prior determination step of determining: the one or more surface(s) 4, 5, and/or the one or more portion(s) of the one or more surface(s) 4, 5, and/or the one or more edge(s) 6, 7, 8, 9, and/or the one or more portion(s) of the one or more edge(s) 6, 7, 8, 9 to be decorated. It may involve all or part of the surfaces 4, 5 and/or the edges 6, 7, 8, 9 whether or not covered with one or more layer(s) of one or more enamel(s).

Preferably, the method according to the invention comprises a prior step of determining the one or more pattern(s) to be produced, and a configuration step for configuring a motion control system that controls the movements of the substrate holder 10 and/or the transfer substrate 11 and/or the LASER source 13. The one or more pattern(s) may be or may comprise a uniform, continuous or discontinuous layer, inscriptions, signs, geometric shapes/forms, logos, images, which replicate the surface appearance and/or the feel of: a machined metal, for example a polished metal, embossed metal or brushed metal; or indeed a material made of carbon fibres; or indeed a natural material, such as for example wood.

Preferably, the method according to the invention comprises a prior step of pre-treatment of one or both of the two surfaces 4, 5 and/or one or more edge(s) 6, 7, 8, 9 of the substrate 2, whether or not covered with enamel, the pre-treatment consisting in: removing the surface contaminants; or surface structuring, to be at least two dimensional, preferably three dimensional; or the creation of surface roughness, over all or part of the one or more surface(s) 4, 5 and/or of the one or more edge(s) 6, 7, 8, 9, whether or not intended to be metallised, either by chemical and/or mechanical action. This makes it possible to enhance the visual appearance and/or the final feel of the decorative panel 1 according to the invention. The chemical means may be any acids or mixtures of acids to which the glass substrate 2 is sensitive, such as for example hydrofluoric acid. The mechanical means may be, or comprise, abrasive materials and/or tools, or LASER ablation, in particular ablation by a femtosecond LASER.

The direct transfer step of directly transferring one or more metal(s) or metal alloy(s) is carried out by disposing the one or more metal film(s) 3, facing, at a distance from, or in direct contact with, at least one of the surfaces 4, 5, or portion(s) of the surface 4 or 5, and/or at least one edge 6, 7, 8, 9, or portion(s) of the edge 6, 7, 8, 9 of the glass substrate 2 to be covered, whether or not the surfaces 4, 5 and/or edges 6, 7, 8, 9 are covered, either partially or completely, with one or more enamel(s). Thus, the one or more metal film(s) 3 are disposed between the glass substrate 2 and the LASER source 13, the reverse side of the one or more metal film(s) 3 being situated under the LASER source 13, such being the case, regardless of whether or not the one or more metal film(s) 3 are deposited on a transfer substrate 11.

Depending on whether the LASER beam 12 is applied respectively in a discontinuous or continuous manner, by respectively, distanced or overlapping passes, the metal layer 14 thus obtained, has a plurality of deposition spots or deposition lines, respectively having a diameter or a width equivalent to the diameter of the LASER beam 12. This causes a pixelation effect and irregularities in the thickness of the metal layer.

Preferably, the method according to the invention further comprises a step of taking one or more masks, that are opaque to the LASER beam 12, and disposing the mask(s) on the metal film(s) 3, or between the latter and the surface 4 or 5 or the edge 6, 7, 8, 9 of the glass substrate 2 to be covered, in contact with or at a distance from the surface 4 or 5 or from the edge 6, 7, 8, 9 to be covered.

The decoration step of decorating the substrate 2, that is to say effecting the deposition of the metal layer in a given predetermined pattern, is performed by using a pulsed LASER beam 12 which is applied at ambient temperature and under atmospheric pressure, on the reverse side of the one or more metal film(s) 3 in the solid state, in order to directly transfer the one or more metal(s) or metal alloy(s) of which they are composed onto all or part of the surface 4, 5 and/or the edge 6, 7, 8, 9 of the substrate 2, and/or onto all or part of the one or more enamel(s) covering the surface 4, 5 and/or the edge 6, 7, 8, 9, in order to form a metal layer 14, which covers, in continuous or discontinuous fashion, all or part of the one or more enamel(s) and/or the surface 4, 5 and/or the edge 6, 7, 8, 9 of the substrate 2, or reproduces the predetermined pattern(s) thereon.

The use of the pulsed LASER beam 12 causes the one or more metal(s) or metal alloy(s) to set and adhere directly onto the substrate 2 made of glass, without requiring the use of a bonding sub-layer, of a glue or adhesive, or any polymer, and therefore of a polymerisation step.

For example, for a layer 14 of aluminum of 10 μm thickness, deposited on a glass surface, the peel strength, tested at 22° C. using a sclerometer or test hammer is 20 Newtons.

The LASER beam 12 has appropriate levels of energy and speed, which is a function of the distance of the LASER source 13 relative to the one or more metal film(s) 3 and the distance between the one or more metal film(s) 3 and the glass substrate 2. In any event, the laser source 13 is positioned in a manner such that the laser beam 12 is focused on the reverse side of the one or more metal film(s) 3.

Preferably, the LASER beam 12 is generated by a femtosecond LASER, that produces pulses whereof the frequency is between 1 kHz and 2 MHz and the duration is in the order of a few femtoseconds to a few hundred femtoseconds, and having a wavelength of between 300 nm and 10 μm.

During the metal transfer process, the LASER beam 12 and the substrate 2 made of glass or the one or more metal film(s) 3 exhibit a relative motion in relation to one another. Preferably, the LASER source 13 is mounted so as to be movable relative to the glass substrate 2 or to the substrate holder 10, if it is present; and/or to the one or more metal film(s) 3 or to the transfer substrate 11 if present. Nevertheless, it is possible for it to be the glass substrate 2, or the substrate holder 10, and/or the one or more metal film(s) 3, or the transfer substrate 11, that are in motion, or indeed for all of the foregoing to be in motion at the same time, or indeed in sequential manner. This presents the advantage of being able to cover one or more surface(s) and/or one or more edge(s).

The pulsed LASER beam 12 is applied in a continuous or repeated manner, until the completion of the predetermined pattern, which may consist in the covering of all or part of at least one or both of the two surfaces 4, 5 and/or of at least one edge 6, 7, 8, 9 of the substrate 2 made of glass, and/or of the one or more enamel(s) which cover them, the number of repetitions being a function of the size of the laser beam 12 spot and/or of the surface to be coated.

In one particular embodiment, the method may comprise the provision of one or more mask(s), not transparent to the LASER beam 12, which may be disposed on the one or more metal film(s) 3 or between the one or more metal film(s) 3 and the surface 4, 5 or the edge 6, 7, 8, 9 of the substrate 2 to be metallised.

In the embodiments in which the one or more metal film(s) 3 are in contact with the surface 4, 5 or the edge 6, 7, 8, 9 to be covered, the surplus of the one or more metal film(s) 3 that does not adhere to the substrate 2 is removed by disbonding, for example by using peeling means, blowing means or the like.

The at least first metal layer 14 has a thickness of between 10 and 300 μm.

The metal transfer step may be repeated several times in order to apply a multitude of homogeneous layers of one particular given metal or metal alloy, or of different metals and/or different metal alloys, it being possible for the different layers to be superimposed, overlapping, or adjacent, with the total thickness of the layers preferably being between 20 and 300 μm, and the patterns possibly being identical or different. For example, it is possible to form lines, signs or words, produced from one or multiple different metal(s) or metal alloy(s) on one uniform layer of one or more other metal(s) or metal alloy(s) that uniformly cover all or part of one of the surfaces 4, 5 or one edge 6, 7, 8, 9 of the glass substrate 2 and/or of the one or more enamel(s) which cover them.

In the embodiments in which only one of the two surfaces 4 and 5 or only one of the edges 6, 7, 8, 9 of the glass substrate 2 is covered with the metal layer 14, the other surface 4 or 5 or the other opposite edge 6, 7, 8, 9, or the other edges 6, 7, 8, 9, may be covered with one or more paints, or with one or more coloured enamels, in order to enhance the visual appearance of the surface 4 or 5 or of the edge 6, 7, 8, 9 that comprises the metal layer 14, for example by giving the substrate 2 made of glass a mirror-like appearance within its thickness or from the one or more edge(s) 6, 7, 8, 9 of the substrate 2.

In the embodiments in which the two surfaces 4 and 5 or at least two edges 6, 7, 8, 9 of the substrate 2 made of glass are decorated, the substrate 2 may be fixed and the LASER source 13 and the one or more metal film(s) 3, possibly the transfer substrate 11 if it is present, may be movable and set in motion, in order to position itself so as to be facing the second surface 4 or 5 or the second edge 6, 7, 8, 9 to be covered; nevertheless, in the embodiment in which the substrate 2 is deposited on a substrate holder 10, the latter will be made of a material that is transparent to the LASER beam 12. However, in an easier manner, the LASER source 13 and the one or more metal film(s) 3, possibly the transfer substrate 11 if it is present, are fixed and it is the substrate 2, or the substrate holder 10 thereof if it is present, which is movable, and set in rotational motion, along the axis Z-Z′, in order to position the second surface 4 or 5 or the second edge 6, 7, 8, 9 to be facing the one or more metal film(s) 3.

The method according to the invention thereafter comprises a step of post-treatment, subsequent to the metal transfer step. This post-treatment is a surfacing step for surfacing the top surface 15 of the metal layer 14 which is carried out by using surfacing means.

In the embodiments in which the two surfaces 4 and 5; one surface 4 and 5 and one edge 6, 7, 8, 9; or at least two edges 6, 7, 8, 9; of the glass substrate 2 are decorated, the surfacing step may be carried out after the covering of the surfaces 4, 5, of the two edges 6, 7, 8, 9; or after the covering of each surface 4, 5 or each edge 6, 7, 8 9.

The step of surfacing consists in altering the surface condition of the top surface 15 of the metal layer 14, which exhibits a pixelation effect and/or irregularities related to thickness or surface; homogenising and levelling it out, which thus serves to reduce the effect of pixelation and/or the irregularities, generated by the direct metal transfer by the LASER beam 12 spot. The metal layer 14 thus has the visual appearance and/or the feel of a metal which has been machined, that is to say the visual appearance and/or texture of a metal that has been subjected to work processes using shaping/forming tools after casting or moulding, and possibly rolling. For example the visual appearance and/or the texture may be like that of a polished metal, brushed metal, embossed metal and/or goffered metal.

The decorative patterns comprising of, or being, inscriptions, signs, logos or images, thus have sharper contours and therefore a visual appearance without much blurring, as well as a smoother feel.

The surfacing may be effected chemically, but it is preferably a mechanical process, which has the advantage of providing for results in respect of visual aspects and/or feel, that are identical or closer to those obtained by means of metal sheet shaping/forming tools.

The mechanical surfacing treatment may comprise, or consist of, for example, a step of polishing, for example by means of a tool and a material for: polishing; brushing, for example with a planar abrasive or a brush, in order to create fine scratches; embossing; or goffering in order for example to obtain the appearance and/or feel like that of carbon fibres, or a combination thereof. Preferably, the surfacing treatment does not include the use of a laser beam, and in particular does not include laser ablation.

The method according to the invention may further comprise a step of covering the top surface 15 of the metal layer 14 after the surfacing treatment step, and possibly also the one or more layer(s) of one or more enamel(s) if they are present, with a protective varnish coating, that is preferably polymeric, and advantageously transparent, which does not alter the visual appearance and/or the feel of the top surface 15 of the metal layer 14.

The decorative panel 1 according to the invention is preferably obtained based on the method according to the invention described above.

The decorative panel 1 according to the invention comprises of a substrate 2 made of glass, as described above, that comprises at least one first surface 4, which is continuous and substantially planar; preferably also a second surface 5, which is continuous and substantially planar, opposite the first surface 4; preferably also at least a first lateral edge 6, and possibly a second lateral edge 7, opposite the first lateral edge 6; a leading-front edge 8 and a trailing-rear edge 9, opposite the leading-front edge 8.

One or both of the two surfaces 4, 5 and/or one or more edge(s) 6, 7, 8, 9, are covered, totally or partially, with a coating comprising at least one layer 14 composed of one or more metal(s) or metal alloy(s), with the deposition thereof being obtained by direct transfer of the one or more metal(s) or metal alloy(s) onto the substrate, making use of a LASER beam 12, preferably pulsed, which is applied directly onto one or more metal film(s) 3 or sheet(s) in the solid state, at ambient temperature and under atmospheric pressure. The metal layer 14 obtained adheres directly to the one or more surface(s) 4, 5 and/or to the one or more edge(s) 6, 7, 8, 9, on which it is applied without requiring the use of a bonding sub-layer, of a glue or adhesive, or any polymer.

In particular embodiments of the invention, the decorative panel 1 comprises all or part of one or both of the two surfaces 4, 5 and/or one or more of the edges 6, 7, 8, 9 covered with one or more enamel(s), disposed in a manner so as to be superimposed or adjacent relative to one another, it being possible for the metal layer 14 to cover, or not cover, totally or partially, the one or more enamel(s). In these embodiments, the coating of the substrate 2 comprises the metal layer 14 and the one or more layer(s) of enamel(s).

The metal layer 14 has a thickness comprised between 10 and 300 μm, and may comprise a multitude of homogenous thin layers of one particular given metal or metal alloy, or of different metals and/or different metal alloys, which are superimposed, adjacent or overlapping relative to each other.

The metal layer 14 forms, on the one or more surface(s) 4, 5 and/or the one or more edge(s) 6, 7, 8, 9, of the glass substrate 2, one or more patterns, that are superimposed, adjacent, or overlapping, the patterns being inscriptions, signs, logos or images.

The metal layer 14 has a top surface 15 which, after the direct deposition of a single metal or of one or more metal alloy(s), exhibited a pixelation effect and/or irregularities in thickness, which has been surfaced, in order to obtain the visual appearance and/or tactile aspects of a metal that has been machined, which appears to have been obtained by means of metal sheet shaping/forming tools. Preferably, the appearance and/or feel is like that of polished metal, brushed metal, embossed metal, or goffered metal, or a combination thereof; preferably obtained by a mechanical surfacing process, for example polishing, brushing, embossing or goffering. Thus, the one or more decorative pattern(s) formed by the metal layer 14 is sharper and has a smoother feel.

Preferably, the decorative panel 1 according to the invention further comprises a protective varnish coat covering the top surface 15 of the metal layer 14, that advantageously does not alter the visual appearance and/or the feel of the top surface 15 of the metal layer 14. In this embodiment the coating of the substrate 2 comprises the metal layer 14, the layer of protective varnish, and optionally also the one or more layer(s) of enamel(s) if they are present.

The decorative panel 1 according to the invention may comprise a metal layer 14 on both of the two surfaces 4 and 5 and/or one or more edge(s) 6, 7, 8, 9 of the glass substrate 2; or indeed one of surfaces 4 or 5 or one of the edges 6, 7, 8, 9, is covered with the metal layer 14 and the other surface 4 or 5 or the opposite or adjacent edge 6, 7, 8, 9, is covered with one or more paint(s) or one or more coloured enamel(s) that enhance the visual appearance of the first surface 4 or 5 comprising the metal layer 14.

Preferably, the decorative panel 1 according to the invention is used for decorating electrical home appliances, such as for example an oven or refrigerator, a heating device, for example a radiator or towel warmer; or for decorating a room in a housing unit, such as for example a kitchen or bathroom; or for decorating furniture.

1. A method for producing a decorative panel, comprising the following steps:
taking a substrate made of glass, comprising at least one first surface,
taking one or more solid metal films, made of one or more metal(s) or metal alloy(s);
taking a LASER source, capable of generating a pulsed LASER beam;
effecting a direct metal deposition on at least the first surface, by disposing the one or more metal film(s) facing, at a distance from or in contact with, the at least first surface, between the substrate made of glass and the LASER source, and by applying the LASER beam on the one or more metal film(s) in order to transfer the one or more metal(s) or metal alloy(s) directly onto the at least first surface, according to a given predetermined pattern, in order to form a coating comprising a metal layer covering all or part of the at least first surface, the metal layer comprising a top surface;
surfacing the top surface using surfacing means, in order to alter the surface condition thereof, so as to give it the visual appearance and/or the feel of a metal that has been machined.

2. The method according to claim 1, wherein the surfacing step comprises a step of polishing, brushing, embossing, goffering, or a combination thereof.

3. The method according to claim 1, wherein the step of depositing of the one or more metal(s) or metal alloy(s) of the one or more metal film(s), directly on the at least first surface is repeated several times, in order to apply, on the at least first surface, a multitude of layers made up of one particular metal or metal alloy, or different metals or different metal alloys, it being possible for the layers to be superimposed, overlapping, or adjacent, and to include patterns that may possibly be identical or different between the layers.

4. The method according to claim 1, wherein the step of depositing of the one or more metal(s) or metal alloy(s) of the one or more metal film(s) is repeated in order to form a metal layer covering all or part of the second surface and/or of multiple edges of the substrate made of glass.

5. The method according to claim 1, wherein the one or more metal film(s) are deposited on a surface of a transfer substrate, that is transparent to the LASER beam, the surface being disposed to be facing the at least first surface and/or the at least first edge of the substrate to be covered.

6. The method according to claim 1, further comprising a preliminary step of covering all or part of the substrate made of glass with one or more enamel(s).

7. The method according to claim 1, further comprising a pretreatment step, carried out before the step of transferring the one or more metal(s) or metal alloy(s), and consisting in: removing the surface contaminants present on at least the first and/or the second surface and/or on the one or more edge(s) of the substrate made of glass; or the surface structuring, to be at least two dimensional, of the one or more surface(s) and/or of the one or more edge(s) of the substrate made of glass.

8. The method according to claim 1, wherein the decorative panel is a panel for covering an electrical home appliance, a heating device, a room in a housing unit, or for decorating furniture.

9. A decorative panel comprising a substrate made of glass comprising at least one first surface; the one or two surface(s) and/or one or more edge(s) being covered, totally or partially, with a coating that is composed of at least one metal layer, comprising of one or more metal(s) or metal alloy(s), deposited by direct transfer making use of a LASER beam and forming one or more decorative pattern(s), the metal layer having a top surface, which has been surfaced in order to obtain the visual appearance and/or the feel of a metal that has been machined.

10. The decorative panel according to claim 9, wherein the visual appearance and/or feel of a machined metal is selected from among the visual appearance and/or feel of a polished metal, brushed metal, goffered metal, or embossed metal, or a combination thereof.

11. The decorative panel according to claim 9, wherein the metal layer comprises of a multitude of layers of one particular metal or metal alloy, or of different metals and/or different metal alloys, the layers being superimposed, adjacent or overlapping relative to each other.

12. The decorative panel according to claim 9, wherein the top surface of the metal layer is covered with a protective varnish coating which does not alter the visual appearance and/or the feel of the top surface.

13. A method comprising applying the decorative panel according to claim 9, for decorating an electrical home appliance or a heating device, for decorating a room in a housing unit, or for decorating furniture.
